(19) United States
(12) Patent Application Publication
(10) Pub. No.: US 2007/0172265 A1
(43) Pub. Date: Jul. 26, 2007

(54) IMAGE FORMING DEVICE

(75) Inventor: Akira Matayoshi, Osaka (JP)

Correspondence Address: GLOBAL IP COUNSELORS, LLP, 1233 20TH STREET, NW, SUITE 700, WASHINGTON, DC, 20036-2680, US

(73) Assignee: Kyocera Mita Corporation, Osaka (JP)

(21) Appl. No.: 11/275,632

(22) Filed: Jan. 20, 2006

(30) Foreign Application Priority Data
Jan. 20, 2006 (JP) 2005012971

(51) Int. Cl. G03G 15/01; G03G 15/16

(52) U.S. Cl. 399/302; 399/313

(57) ABSTRACT

An intermediate transfer belt 24 includes an elastic layer 242 on a resin layer 241. The material of the secondary transfer roller 31 has a hardness of 65° which is higher than a hardness of 60° of the material of the drive roller 25a. As a result, when the secondary transfer roller 31 is pressed against the drive roller 25a via the transfer medium and the intermediate transfer belt 24, the elastic layer 242 formed on the intermediate transfer belt 24 is elastically deformed to decrease the stress concentration in the toner at the pressing position, which suppresses the defect of transferred toner which is generated as a result of the stress concentration in the toner at the pressing position.

### BACKGROUND OF THE INVENTION

1. Field of the Invention

The present invention relates to an image forming device, particularly to an image forming device in which a latent image formed on an image carrying member is developed into a toner image by a developing unit, and the developed image is then transferred to a transfer medium by an intermediate transfer belt.

2. Background Information

Multiple drum type (tandem-type) image forming devices, especially multiple drum type (tandem-type) color image forming devices such as color copying machines and color printers, typically perform faster processing than single drum type, and have been becoming mainstream. Tandem-type color image forming devices have color image forming units such as magenta, yellow, cyan, and black, for example, arranged along the transfer medium conveyance direction. These color image forming units sequentially form different color toner images.

The color image forming units are located so as to be opposed to an intermediate transfer belt (an image carrying member), so that color toner images sequentially formed in the image forming units are transferred to the intermediate transfer belt. The intermediate transfer belt is endless, and is looped over a plurality of support rollers so that the toner images on the intermediate transfer belt are transferred to a transfer medium by a transfer unit such as a transfer roller, while the transfer medium is transported to a transfer position from a feed unit via a pair of paper stop rollers.

In the transfer process in this type of image forming device, the transfer roller is pressed against the support roller via the intermediate transfer belt so that the toner image formed on the intermediate transfer belt is transferred to the transfer medium. At this time, stress will be concentrated on the toner on the intermediate transfer belt due to the transfer roller being pressed against the support roller, and thus image deformation, defects in the transferred toner image, or the like may occur.

In order to obtain a high quality image not having image distortion, defects in the transferred toner image, or the like, the rigidity of the transfer roller or the support roller may be lowered. For example, although the purpose is different, Japanese Patent Application Publication 2003-15442 discloses an elastic transfer roller and a rigid support roller being pressed against each other to deform the transfer roller. Conversely, Japanese Patent Application Publication 2002-174966 discloses a support roller opposed to the transfer roller that is made of a material whose hardness is lower than that of the transfer roller.

However, as shown in Japanese Patent Application Publication 2003-15442, in a structure in which the support roller opposed to the transfer roller is made of a material whose hardness is higher than that of the transfer roller, although the durability of the intermediate transfer belt is improved, a transfer medium being discharged from the transfer unit may tilt toward a non-fixed toner image, and a non-fixed toner image may come into contact with components surrounding the non-fixed toner image, and therefore the image may become damaged. Furthermore, in the structure shown in Japanese Patent Application Publication 2003-174966, since the transfer medium discharged from the transfer unit is not tilted toward the non-fixed toner image, damage to the image due to contact between the non-fixed toner image and the components surrounding will not occur, but the problem of stress being concentrated on the toner will continue to occur.

In view of the above, there exists a need for an image forming device which overcomes the above mentioned problems in the prior art. This invention addresses this need in the prior art as well as other needs, which will become apparent to those skilled in the art from this disclosure.

### SUMMARY OF THE INVENTION

According to a first aspect of the present invention, an image forming device comprises at least one image forming unit, an intermediate transfer belt, and a transfer roller. The image forming unit develops a latent image formed on an image carrying member. The intermediate transfer belt is looped over a plurality of support rollers, and the toner image formed by the image forming unit is transferred onto the belt. The transfer roller is pressed against one of the support rollers via the intermediate transfer belt to transfer the toner image formed on the transfer belt onto a transfer medium. The intermediate transfer belt has an elastic layer elastically deformable in the thickness direction. The hardness of the transfer roller is equal to or higher than that of the support roller against which the transfer roller is pressed.

In this device, a toner image formed by the image forming unit is transferred to the intermediate transfer belt. The intermediate transfer belt is endless and is looped over the support rollers, and the transfer medium is conveyed to a nip portion between the intermediate transfer belt and the transfer roller. Then, as the transfer roller presses a support roller which is positioned opposite the transfer roller, the transfer roller presses a transfer medium, and then the transfer medium is placed in contact with the toner image on the intermediate transfer belt so that the toner image on the intermediate transfer belt is transferred to the transfer medium.

In this device, when the transfer roller presses the support roller via the transfer medium and the intermediate transfer belt, the elastic layer of the intermediate transfer belt is elastically deformed to reduce the concentration of stress on the toner at the pressing position. As a result, defects in the transferred toner which occur due to the concentration of stress on the toner at the pressing position will be inhibited.

Furthermore, in this device, since the transfer roller has a hardness that is equal to or higher than that of the support roller against which the transfer roller is pressed and the elastic layer is formed in the intermediate transfer belt, the support roller and a portion of the intermediate transfer belt corresponding to the support roller will be indented as the transfer roller is pressed against the support roller. As a result, the transfer medium pinched between the transfer roller and the intermediate transfer belt is tilted toward the transfer roller so that the transfer medium onto which the toner image is transferred will likely separate from the intermediate transfer belt.

According to a second aspect of the present invention, the support roller against which the transfer roller is pressed is a drive roller for driving the intermediate transfer belt. The drive roller is set such that fluctuation in the circumferential velocity of the intermediate transfer belt due to a change in the thickness of the drive roller is 0.1% or less.

In this device, since the hardness of the support roller as a drive roller is equivalent to or less than that of the transfer roller, the drive roller is deformed in order to change the size in the diametrical direction thereof when the transfer roller is pressed against the drive roller. As a result, the circumferential velocity of the intermediate transfer belt may fluctuate.

Therefore, in the present invention, by setting the fluctuation in the circumferential velocity of the intermediate transfer belt generated due to the change in the diameter of the drive roller to 0.1% or less, the fluctuation in the circumferential velocity of the intermediate transfer belt due to the change in the diameter of the drive roller is within an allowable range, thus improving the superimpose accuracy of the toner images transferred from the image forming units.

According to a third aspect of the present invention, the intermediate transfer belt is pressed against the drive roller by the transfer roller, and a nip portion of the intermediate transfer belt is elastically deformed in accordance with the curvature of the transfer roller.

According to a fourth aspect of the present invention, the intermediate transfer belt further includes a first resin layer laminated on the side of the elastic layer near the support roller.

According to a fifth aspect of the present invention, the intermediate transfer belt further includes a second resin layer laminated on the side of the elastic layer opposite the first resin layer.

According to a sixth aspect of the present invention, the first resin layer is larger than the second resin layer in thickness, and the elastic layer is larger than the first resin layer in thickness.

According to a seventh aspect of the present invention, the transfer roller is a solid roller.

According to an eighth aspect of the present invention, the drive roller includes a hollow core bar and an elastic layer formed on a surface of the hollow core bar.

According to the present invention, since the intermediate transfer belt is formed of at least two layers, including an elastic layer formed on the resin layer for preventing stretch, defects in the transferred toner will be inhibited.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a cross-sectional view of the primary components of a color printer;

FIG. 2 is an enlarged view of a black image forming unit in the color printer of FIG. 1;

FIG. 3 is a cross-sectional view of a transfer belt of the color printer of FIG. 1; and

FIG. 4 is an enlarged view of a transfer unit of the color printer of FIG. 1.

### DETAILED DESCRIPTION OF THE PREFERRED EMBODIMENTS

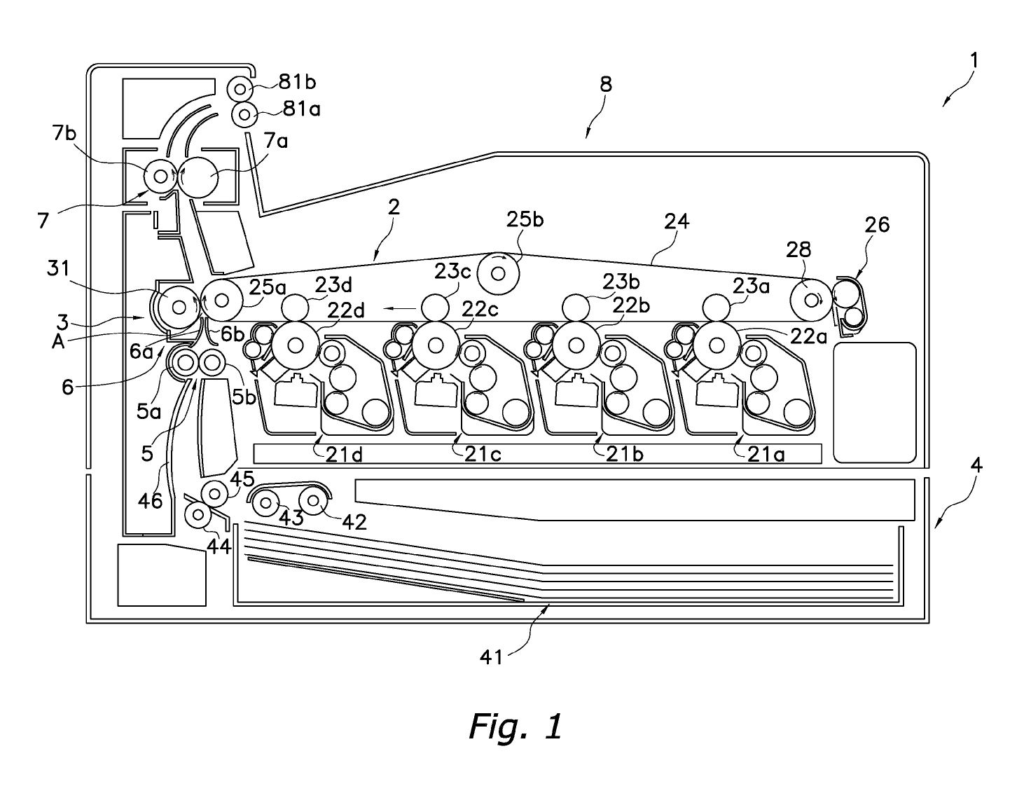

FIG. 1 is a cross-sectional view of a tandem-type color printer 1 in which an embodiment of the present invention is employed. The color printer 1 includes an image forming unit 2 for forming color images, a transfer unit 3 for transferring toner images formed by the image forming unit 2 to transfer media, a feed unit 4 for feeding the transfer media to the transfer unit 3, a paper stop roller unit 5 for synchronizing the conveyance of the transfer media and image formation, a transfer medium conveyance guide mechanism 6 for guiding a transfer medium which has reached the paper stop roller unit 5 to the transfer position, a fixing unit 7 for fixing a toner image onto a transfer medium, and a copy receiving unit 8 for discharging transfer media.

The image forming unit 2 is located generally at the center of the color printer and includes four image forming units 21a, 21b, 21c, and 21d. The four image forming units 21a to 21d correspond to four colors, including black, yellow, cyan, and magenta, respectively, and have photoconductive drums 22a, 22b, 22c, and 22d, respectively, on the surfaces of which electrostatic latent images are formed.

It should be noted that the internal structures of the four image forming units corresponding to the four colors including black, yellow, cyan, and magenta are equivalent, and therefore, the structure of each image forming unit will be described with reference to the black image forming unit 21a.

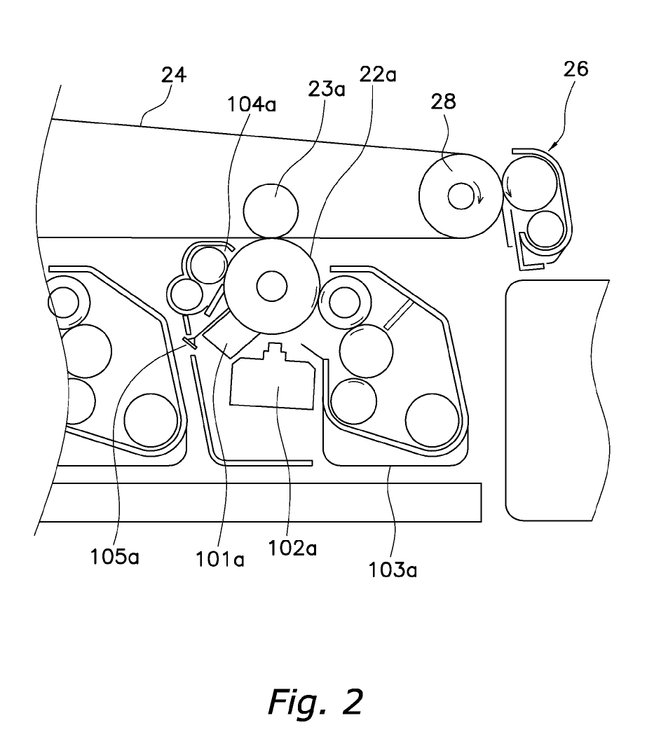

As shown in FIG. 2, a charge unit 101a, an exposure unit 102a, a developing unit 103a, a cleaning unit 104a, and a discharge unit 105a are disposed around the photoconductive drum 22a of the black image forming unit 21a. The charge unit 101a charges the surface of the photoconductive drum 22a. The exposure unit 102a exposes the surface of the photoconductive drum 22a with light in accordance with image data in order to form an electrostatic latent image. The developing unit 103a supplies toner to the surface of the photoconductive drum 22a in order to form a toner image. The cleaning unit 104a removes residual toner on the surface of the photoconductive drum 22a. The discharge unit 105a removes the charge on the surface of the photoconductive drum 22a.

The transfer unit 3 includes four primary transfer rollers 23a, 23b, 23c, and 23d, an intermediate transfer belt 24, and a secondary transfer roller 31. The four primary transfer rollers 23a to 23d are arranged opposite the photoconductive drums 22a, 22b, 22c, and 22d, respectively, in order to transfer the toner images formed on the photoconductive drums. The intermediate transfer belt 24 is a member onto which the toner images on the primary transfer rollers 23a to 23d are successively transferred. The secondary transfer roller 31 is pressed against the intermediate transfer belt 24 via a transfer medium. By means of a secondary transfer bias applied to the secondary transfer roller 31, a full-color toner image formed on the intermediate transfer belt 24 is transferred to a transfer medium. The secondary transfer roller 31 is a solid roller having a diameter of 20 mm. The secondary transfer roller 31 employs NBR (butadiene-acrylonitrile rubber) material wherein JIS-A hardness is 650 and the volume resistance is 1*107 Ωcm.

The feed unit 4 is located under the image forming unit 2, and includes a cassette 41 for accommodating transfer media, pick-up rollers 42 and 43 for picking up sheets of transfer media in the cassette 41, and a pair of feed rollers 44 and 45 for feeding individual sheets of transfer media into the conveyance path. A transfer medium fed by the feed unit 4 is conveyed to the transfer position via a vertical transport path 46. A pair of paper stop rollers 5a and 5b are located downstream of the vertical transport path 46 in the conveyance direction, and place the transfer medium fed from the feed unit 4 into a wait state, and then forwards the transfer medium to the transfer position A in synchronization with the toner image formed on the intermediate transfer belt 24.

The fixing unit 7 is located above the transfer unit 3, and fixes the toner transferred onto the transfer medium by fusing. The fixing unit 7 includes a heat roller 7a having a built-in heater and a pressure roller 7b which is pressed against the heat roller 7a. Both the rollers 7a and 7b pinch the transfer medium therebetween and convey the transfer medium to fix the toner image transferred to the surface of the transfer medium by fusing. Above the fixing unit 7 are provided discharge rollers 81a and 81b through which the transfer medium having the toner image is discharged to the copy receiving unit 8 provided at the uppermost portion of the color printer.

The intermediate transfer belt 24 is, as shown in FIG. 1, provided above the photoconductive drums 22a, 22b, 22c, and 22d. The intermediate transfer belt 24 is looped over a drive roller 25a and a driven roller 28 under tension in order to be driven. The intermediate transfer belt 24 is driven by a drive means such as a motor not shown in the drawings, and the driven roller 28 is located apart from the drive roller 25a. Between the drive roller 25a and the driven roller 28 is provided a tension roller 25b, which is driven by a tension adjustment mechanism not shown in the drawings, in order to properly maintain tension of the intermediate transfer belt 24. The primary transfer rollers 23a, 23b, 23c, and 23d are urged against the photoconductive drums 22a, 22b, 22c, and 22d, respectively, via the intermediate transfer belt 24. Accordingly, the intermediate transfer belt 24 is pressed against the photoconductive drums 22a, 22b, 22c, and 22d. In addition, an intermediate transfer cleaning unit 26 for removing the toner adhered to the intermediate transfer belt 24 is provided at a position opposite the driven roller 28.

It should be noted that drive roller 25a comprises a hollow core bar and an elastic member having a diameter of 30 mm and a thickness of 0.5 mm. Preferably, the elastic member is comprised of EPDM (ethylene-propylene-dienepolyethylene), wherein the JIS-A hardness is 60° and the volume resistance is 3*105 Ωcm. Accordingly, the JIS-A hardness (65°) of the material forming the secondary transfer roller 31 is higher than the JIS-A hardness of the material forming the drive roller 25a.

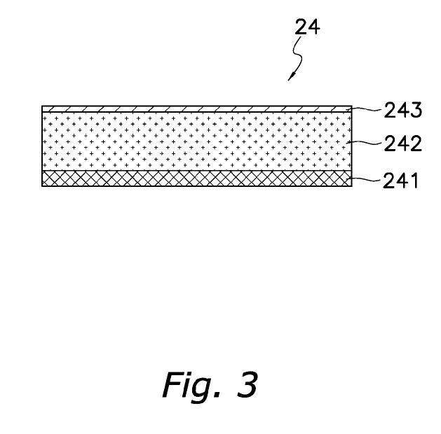

The intermediate transfer belt 24 has, as shown in FIG. 3, a three layer construction. More specifically, the intermediate transfer belt 24 comprises three laminated layers, including a first resin layer 241 on the side which contacts the drive roller 25a, a second resin layer 243 on the side which contacts the secondary transfer roller 31, and an elastic layer 242 sandwiched between the resin layers 241 and 243. The first resin layer 241 is made of PI (polyimide), which is less elasticized, in order to prevent stretch, and has a thickness of 100 μm. The second resin layer 243 is a fluorine resin layer made of fluorine (PTFE)-containing urethane emulsion, and has a thickness of 5 μm. The elastic layer 242 is made of NBR having JIS-A hardness of 50°, and has a thickness of 500 μm. The elastic layer 242 is deformable in the thickness direction.

Next, the image forming operation will be described. First, when the color printer is turned on, various parameters are initialized, e.g., the temperature of the fixing unit. An image data input unit not shown in the drawings receives image data from a personal computer through a network. The received image data is sent to the image forming unit 2.

Each of the image forming units 21a, 21b, 21c, and 21d in the image forming unit 2 forms a toner image in accordance with the received image data. The image forming operation of the black image forming unit 21a is described as an example hereinafter.

First, the charge unit 101a charges the photoconductive drum 22a, then the exposure unit 102a exposes the photoconductive drum 22a with light in accordance with the black image data to form an electrostatic latent image on the surface of the photoconductive drum 22a. The electrostatic latent image is developed into a toner image by means of the black developing unit 103a, and then the toner image is transferred onto the intermediate transfer belt 24 by means of a transfer bias applied to the primary transfer roller 23a. The residual toner remaining on the photoconductive drum 22a is removed by means of the cleaning unit 104a and is discarded into a waste toner container not shown in the drawings. The discharge unit 105a discharges any charge remaining on the photoconductive drum 22a. In the magenta image forming unit 21b, the cyan image forming unit 21c, and the yellow image forming unit 21d, the same operation is carried out in order to form a full-color toner image on the intermediate transfer belt 24.

Simultaneously, in the feed unit 4, a sheet of transfer medium is picked up by the pick-up rollers 42 and 43 from the paper feed cassette 41, and then is forwarded to the vertical transport path 46 by the pair of feed rollers 44 and 45. After that, the transfer medium is conveyed from the pair of paper stop rollers 5a and 5b in synchronization with the image formed on the intermediate transfer belt 24, and then is guided to the transfer unit 3 by the transfer medium conveyance guide mechanism 6. In the transfer unit 3, the secondary transfer roller 31 is in contact with the intermediate transfer belt 24 via the transfer medium in order to transfer the full-color toner image formed on the intermediate transfer belt 24 to the transfer medium by means of the secondary transfer bias applied to the secondary transfer roller 31. Finally, the full-color toner image transferred to the transfer medium is fixed by means of the heat and pressure of the fixing unit 7. The transfer medium with the full-color toner image formed thereon is discharged onto the copy receiving unit 8. The toner remaining on the intermediate transfer belt 24 is removed by the intermediate transfer cleaning unit 26, and discarded into the waste toner container.

In the above-mentioned image forming process, when the drive roller 25a is driven by a drive device, the intermediate transfer belt 24 starts running. Then, a transfer medium conveyed from the pair of paper stop rollers 5a and 5b is guided to the nip portion between the secondary transfer roller 31 and the intermediate transfer belt 24. At this time, the secondary transfer roller 31 is pressed against the intermediate transfer belt 24. Since the intermediate transfer belt 24 is looped over the drive roller 25a, the secondary transfer roller 31 is pressed against the drive roller 25a via the intermediate transfer belt 24. In the transfer unit 3, when the transfer medium reaches the transfer nip portion, the secondary transfer roller 31 presses the transfer medium first, and then the transfer medium is placed into contact with the toner image on the intermediate transfer belt 24 so that the toner image on the intermediate transfer belt 24 is transferred to the transfer medium. In the above operation, when the secondary transfer roller 31 presses the drive roller 25a via the transfer medium and the intermediate transfer belt 24, the elastic layer 242 formed in the intermediate transfer belt 24 is elastically deformed so that the stress concentration in the toner at the pressing position is reduced. As a result, defects in the transferred toner that are generated by the concentration of stress on the toner at the pressing position will be inhibited.

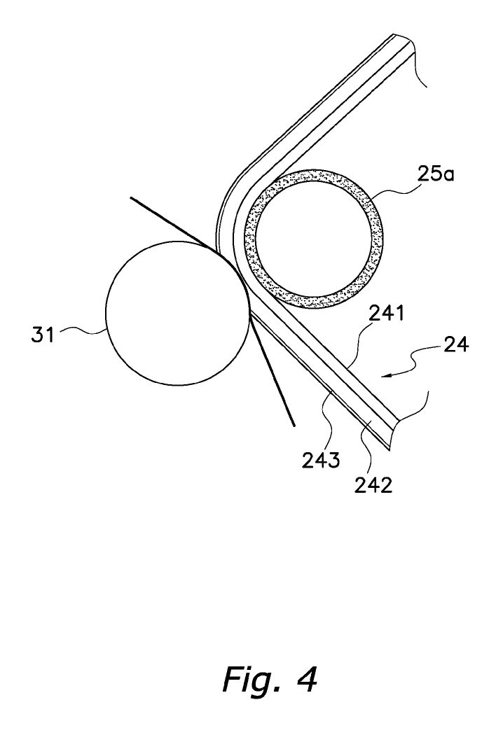

In the present invention, since the material forming the secondary transfer roller 31 has a hardness of 650, which is higher than the hardness of 600 of the material forming the drive roller 25a, and the elastic layer 242 is formed in the intermediate transfer belt 24, as shown in FIG. 4, the intermediate transfer belt 24 will be indented toward the drive roller 25a when the secondary transfer roller 31 presses the drive roller 25a. As a result, the transfer medium pinched between the secondary transfer roller 31 and the intermediate transfer belt 24, as shown in FIG. 4, is tilted toward the secondary transfer roller 31, and the transfer medium to which the toner image is transferred will therefore likely separate from the intermediate transfer belt 24.

Since the hardness of the drive roller 25a is lower than that of the secondary transfer roller 31, the size in the diametrical direction of the drive roller 25a may change to fluctuate the circumferential velocity of the intermediate transfer belt 24 when the drive roller 25a is pressed against the secondary transfer roller 31. In this embodiment, since the fluctuation in the circumferential velocity of the intermediate transfer belt 24 due to the change in the diameter of the drive roller 25a is set to 0.1% or less, the change in the circumferential velocity of the intermediate transfer belt 24 due to the change in the diameter of the drive roller 25a is within an allowable range. As a result, the accuracy at which a plurality of colors transferred by the developing units are superimposed on each other will improve.

In the present invention, the intermediate transfer belt 24 includes the elastic layer 242 in the resin layer 241, and the hardness 650 of the material forming the secondary transfer roller 31 is higher than the hardness 600 of the material forming the drive roller 25a. Accordingly, when the secondary transfer roller 31 is pressed against the drive roller 25a via the transfer medium and the intermediate transfer belt 24, the elastic layer 242 provided in the intermediate transfer belt 24 is elastically deformed to reduce the concentration of stress on the toner at the pressing position, thereby inhibiting defects in the transferred toner that are generated due to the stress concentrated on the toner at the pressing position. Furthermore, the nip portion of the intermediate transfer belt 24 is elastically deformed in accordance with the curvature of the secondary transfer roller 31 so as to be indented toward the drive roller 25a when the secondary transfer roller 31 is pressed against the drive roller 25a, and thus a transfer medium pinched between the secondary transfer roller 31 and the intermediate transfer belt 24 will tilt toward the secondary transfer roller 31. As a result, the transfer medium to which the toner image is transferred will likely separate from the intermediate transfer belt 24.

### Other Embodiment

Although in the present embodiment, a tandem-type color printer is illustrated as an image forming device and a belt is illustrated as an intermediate transfer belt, the present invention can also be applied to a black and white printer that is used as an image forming device and a photoconductive belt or the like that is used as the intermediate transfer belt. Furthermore, the present invention can be applied to other image forming devices such as a copying machine, a printer and a facsimile.

Any terms of degree used herein, such as “substantially”, “about” and “approximately”, mean a reasonable amount of deviation of the modified term such that the end result is not significantly changed. These terms should be construed as including a deviation of at least ±5% of the modified term if this deviation would not negate the meaning of the word it modifies.

This application claims priority to Japanese Patent Application No. 2005-012971. The entire disclosure of Japanese Patent Application No. 2005-012971 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. An image forming device comprising:
at least one image forming unit that develops a latent image formed on an image carrying member;
an intermediate transfer belt looped over a plurality of support rollers, the intermediate transfer belt capable of receiving a toner image formed by the image forming unit; and
a transfer roller pressed against one of the plurality of support rollers via the intermediate transfer belt, the transfer roller capable of transferring the toner image formed on the intermediate transfer belt onto a transfer medium;
wherein the intermediate transfer belt comprises an elastic layer that is elastically deformable in the thickness direction; and
the hardness of the transfer roller is equal to or higher than that of the support roller against which the transfer roller is pressed.

2. An image forming device according to claim 1, wherein the support roller against which the transfer roller is pressed is a drive roller which drives the intermediate transfer belt; and
the drive roller is set such that fluctuation in the circumferential velocity of the intermediate transfer belt due to a change in the thickness of the drive roller is 0.1% or less.

3. An image forming device according to claim 1, wherein the intermediate transfer belt is pressed against the drive roller by the transfer roller, and a nip portion of the intermediate transfer belt is elastically deformed in accordance with the curvature of the transfer roller.

4. An image forming device according to claim 3, wherein the intermediate transfer belt further comprises a first resin layer laminated on a side of the elastic layer near the support roller.

5. An image forming device according to claim 4, wherein the intermediate transfer belt further comprises a second resin layer laminated on a side of the elastic layer opposite the first resin layer.

6. An image forming device according to claim 5, wherein the first resin layer is larger than the second resin layer in thickness, and the elastic layer is larger than the first resin layer in thickness.

7. An image forming device according to claim 1, wherein the transfer roller is a solid roller.

8. An image forming device according to claim 7, wherein the drive roller includes a hollow core bar and an elastic layer formed on a surface of the hollow core bar.
